(19) United States
(12) Patent Application Publication
(10) Pub. No.: US 2007/0055494 A1
(43) Pub. Date: Mar. 8, 2007

(54) Communication Device and Communication Method

(75) Inventor: Susumu Kashiwase, Kanagawa (JP)

Correspondence Address: HOGAN & HARTSON L.L.P., 1999 AVENUE OF THE STARS, SUITE 1400, LOS ANGELES, CA, 90067, US

(73) Assignee: KYOCERA CORPORATION, Kyoto-shi (JP)

(21) Appl. No.: 11/466,038

(22) Filed: Aug. 21, 2006

(30) Foreign Application Priority Data
Aug. 30, 2005 (JP) 2005-250292

(51) Int. Cl. G06F 17/27

(52) U.S. Cl. 704/9

(57) ABSTRACT

A communication device and method is provided which enables effective voice communications. An error detection unit (102) within a base station device (100) detects transmission line errors of an encoded voice frame data from a terminal (200). A voiced-or-unvoiced discrimination unit (104) determines whether or not the encoded voice frame data corresponds to the voiced section. If a transmission error is contained in the encoded voice frame data and the encoded voice frame data corresponds to the voiced section, a retransmission request discrimination unit (105) causes the terminal (200), within the 20 ms frame time corresponding to the encoded voice frame data, to return NAK as a retransmission request and retransmit the encoded voice frame data, using forward communication time slots in a retransmission 5-ms frame.

### BACKGROUND OF THE INVENTION

The present invention relates to a communication device and method for decoding received encoded voice information on a frame-by-frame basis.

In wireless communication technology, encoding voice and transmitting the encoded voice is widely available. For example, ITU-T Recommendation G.729, G.723 or the like adopted as a voice encoding system in Voice over Internet Protocol (VoIP) applications defines a scheme for encoding voice at intervals of 20 ms or 40 ms.

In such wireless voice communications, the occurrence of transmission line errors may cause significant degradation in voice quality. Therefore, Japanese Unexamined Patent Publication No. 10(1998)-69298 discloses a wireless communication device for decoding encoded voice information on a frame-by-frame basis, wherein a technique is provided for reducing the degradation in voice quality by addressing error frame generation as specified by the voice encoding system as well as by incorporating and reflecting temporary change in error rate in an the error-frame-generation addressing process, when a transmission line error occurs.

In the aforementioned prior art, however, the nature of the voice encoding, i.e., the presence of the voiced section and the unvoiced section in encoded voice information, has not been considered, and therefore effective wireless voice communications have not been carried out.

### SUMMARY OF THE INVENTION

Accordingly, the present invention has been conceived to solve the aforementioned problems and an object of the invention is to provide a communication device and method which allow effective voice communications.

This invention provides a communication device for decoding received encoded voice information on a frame-by-frame basis. The communication device comprises: detection section for detecting a transmission line error of encoded voice information on the frame-by-frame; discrimination/estimation section for discriminating and/or estimating whether or not encoded voice information corresponds to the voiced section on the frame-by-frame; and retransmission request section for requesting retransmission of the voice encoded voice information, from which the detection section detects the transmission line error and which the discrimination/estimation section discriminates and/or estimates as belonging to the voiced section, within a time corresponding to the frame.

With this feature, even when a transmission line error is detected in certain encoded voice information on frame-by-frame, if the encoded voice information corresponds to the unvoiced section, no retransmission request is conducted since such information is not necessary for voice decompression. The retransmission is therefore restricted to the minimum necessary, thus achieving effective voice communications.

Further, according to one embodiment of the invention, if a volume level corresponding to the encoded voice information exceeds a predetermined threshold level, the discrimination/estimation section discriminates and/or estimates that the encoded voice information belongs to the voiced section.

Still further, according to another embodiment of the invention, the discrimination/estimation section discriminates and/or estimates whether or not newly-received encoded voice information corresponds to the voiced section based on a volume level corresponding to the already-received encoded voice information with no transmission line errors.

Still further, according to another embodiment of the invention, the retransmission request section requests retransmission when an unassigned radio resource is present within the time corresponding to the frame.

This invention provides a communication method for decoding received encoded voice information on a frame-by-frame basis. The communication method comprises: a detection step of detecting transmission line errors of the encoded voice information on frame-by-frame; a discrimination/estimation step of discriminating and/or estimating whether or not the encoded voice information corresponds to the voiced section on the frame-by-frame and a retransmission request step of requesting retransmission of the voice encoded voice information, from which the detection step detects transmission line errors and which the discrimination/estimation step discriminates and/or estimates as belonging to the voiced section, within the time corresponding to the frame.

Further, according to one embodiment of the invention, if the volume level corresponding to the encoded voice information exceeds a predetermined threshold level, the discrimination/estimation step discriminates and/or estimates that the encoded voice information belongs to the voiced section.

Still further, according to another embodiment of the invention, the discrimination/estimation step discriminates and/or estimates whether or not newly-received encoded voice information corresponds to the voiced section based on the volume level corresponding to the already-received encoded voice information with no transmission line errors.

Still further, according to another embodiment of the invention, the retransmission request step requests retransmission when an unassigned radio resource is present within the time corresponding to the frame.

In accordance with the present invention, even when a transmission line error is detected in specific encoded voice information, if the encoded voice information corresponds to the unvoiced section, retransmission is not carried out, thus providing effective voice.

### BRIEF DESCRIPTION OF THE DRAWINGS

FIG. 1 is a block diagram of a communication system;

FIG. 2 is a diagram showing an example of data exchange between a base station device and terminals;

FIG. 3 is a flow chart showing operations of the base station device; and

FIG. 4 is a flow, chart showing operations of the terminal.

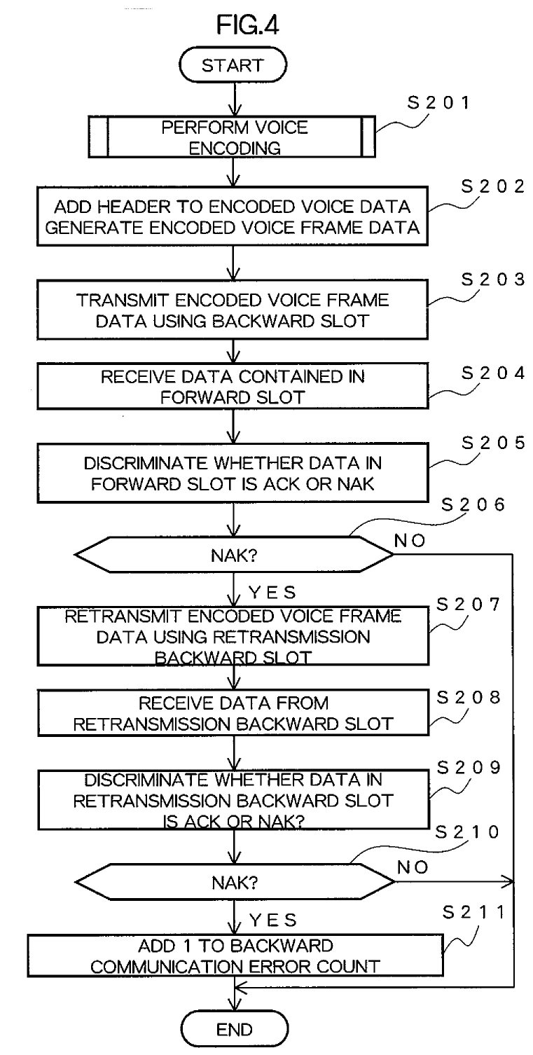

### DESCRIPTION OF THE PREFERRED EMBODIMENT

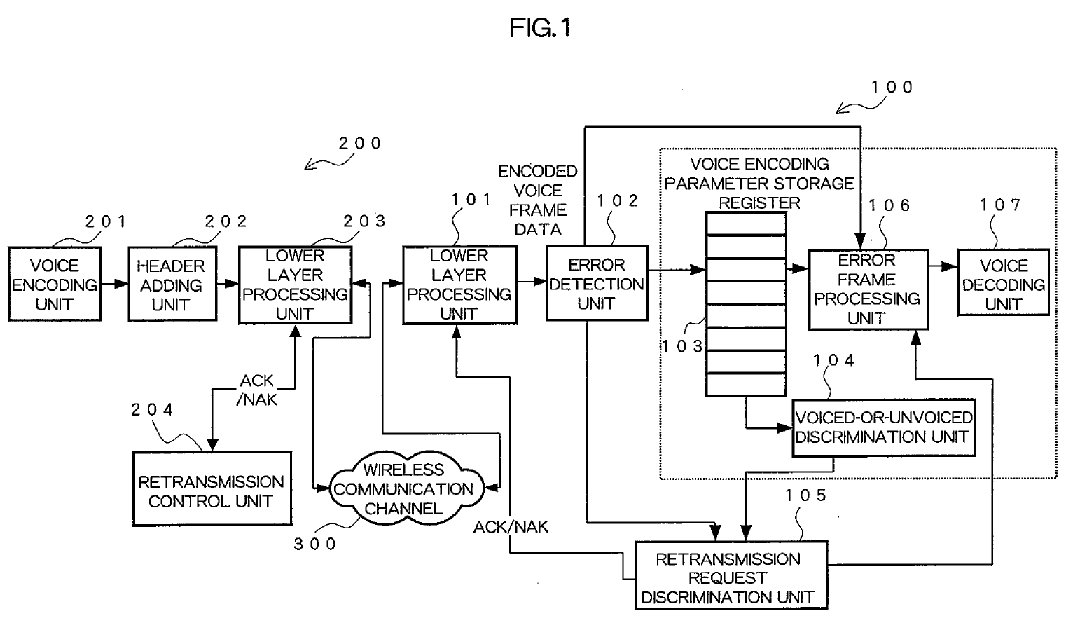

FIG. 1 is a diagram showing the structure of a communication system to which a communication device of the invention is applied.

The communication system shown in FIG. 1 is a Personal Handyphone System (PHS) communication system which comprises a base station device (100) as the communication device of the invention, a terminal (200), and a wireless communication channel (300) through which the base station device (100) and the terminal (200) communicate with each other. Although FIG. 1 shows only one terminal (200), the base station device (100) can communicate with a plurality of the terminals (200).

The base station device (100) comprises a lower layer processing unit (101), an error detection unit (102), a voice encoding parameter storage register (103), a voiced-or-unvoiced discrimination unit (104), a retransmission request discrimination unit (105), an error frame processing unit (106) and a voice decoding unit (107). On the other hand, the terminal (200) comprises a voice encoding unit (201), a header adding unit (202), a lower layer processing unit (203) and a retransmission control unit (204).

In the communication system shown in FIG. 1, a voice encoding scheme is employed which is provided by improving the TDD-TDMA based voice encoding scheme so as to be capable of being used concurrently with VoIP, such that voice call traffic increases. Specifically, the communication system employs a physical layer structure wherein transmission and receiving to and from each terminal (200) are alternately repeated in a cycle of 5 ms per cycle. When a transmission line error occurs during communication between the base station device (100) and the terminal (200), if error compensation is carried out by data retransmission within 20 ms from the occurrence of the error, the communication quality remains high.

In order to maintain the communication quality as mentioned above, the terminal (200) encodes voice information in every 20 ms frame time and adds a header thereto, thereby generating encoded voice frame data corresponding to the 20 ms voice information. Then, the terminal (200) transmits the encoded voice frame data using one of the time slots for backward communication (communication from the terminal (200) to the base station device (100)), which are available every 5 ms within 20 ms.

If the received encoded voice frame data contains a transmission line error and the encoded voice frame data corresponds to the voiced section, within the 20 ms frame time corresponding to the encoded voice frame data the base station device (100) returns NAK as a retransmission request to the terminal (200), using one of the time slots for forward communication (communication from the base station device (100) to the terminal (200)) which are available every 5 ms within 20 ms, and thereby causes the terminal (200) to retransmit the encoded voice frame data. On the other hand, if the received encoded voice frame data does not contain a transmission line error or if the received encoded voice frame data contains a transmission line error while the encoded voice frame data does not correspond to the voiced section, the base station device (100) returns ACK as a notification indicating a normal receipt using one of the time slots for forward communication.

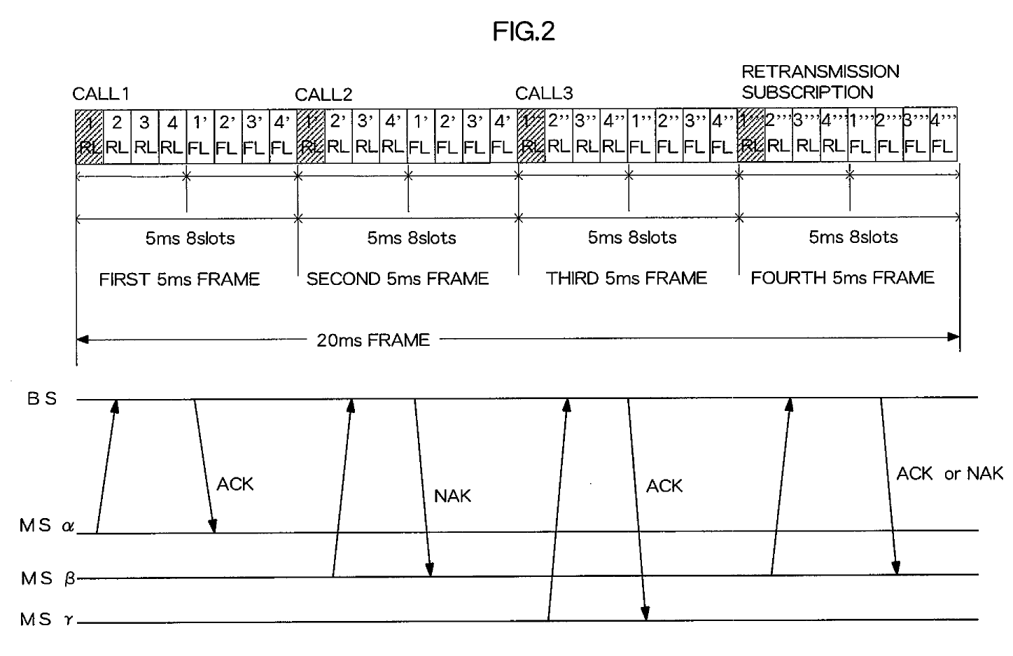

FIG. 2 is a diagram showing an example of data exchange between a base station device (100) (BS) and terminals (200) (MS-α corresponding to communication call CALL1, MS-β corresponding to communication call CALL2 and MS-γ corresponding to communication call CALL3). A frame having a frame time of 20 ms is divided into frames of 5 ms, i.e. a first 5 ms frame to a fourth 5 ms frame. The base station device (100) allocates these 5 ms frames to the terminals (200). As there are four 5 ms frames in 20 ms, the 5 ms frames can be allocated to four terminals (200) at the most. In this embodiment, however, the first to third 5 ms frames are allocated to three terminals (200) (MS-α, MS-β and MS-γ) and the remaining 5 ms frame is reserved for retransmission.

Each 5 ms frame is further divided into eight time slots. Among the eight time slots, the first four time slots are time slots for backward communication (hereinafter referred to as backward-communication time slot) and the latter four time slots are time slots for forward communication (hereinafter referred to as forward-communication time slot). When low-bit-rate voice encoding is preformed at the terminal (200), it is not necessary to use all four backward-communication time slots. In FIG. 2, for example, only one backward-communication time slot (1RL) is used for backward communication from MS-α to BS.

Here, the relationship between the backward-communication time slots and the forward-communication time slots is important. An advantage of the time division duplex (TDD) system is that the backward-communication time slot and forward-communication time slot are the same frequency, which means that the optimized directivity of the terminal (200) in communication using a backward-communication time slot can be applied in the same manner as it is to communication using a forward-communication time slot. Further, in order to ensure communication quality, the backward-communication time slot and the forward-communication time slot should be close to each other time wise. Experience of the present inventors has revealed that the backward-communication time slots and the forward-communication time slots are contained within 5 ms.

Hereinafter, the operations of the base station device (100) and the terminal (200) will be described with reference to flowcharts.

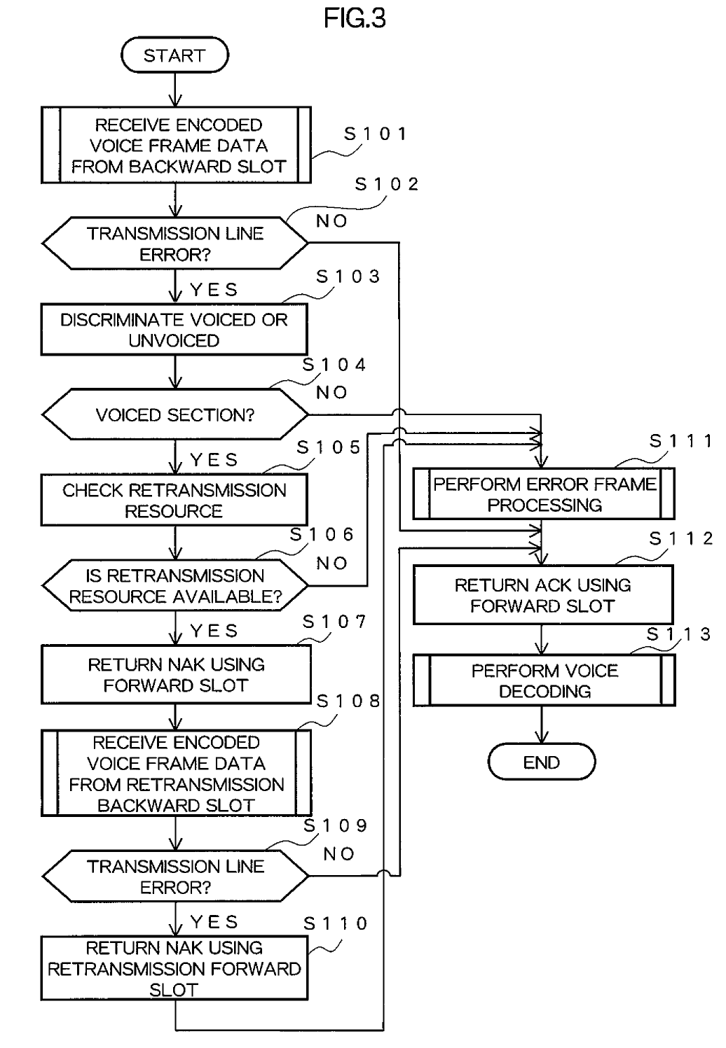

FIG. 3 is a flow chart showing operations of the base station device (100). A lower layer processing unit (101) in the base station device (100) receives encoded voice frame data from a terminal (200), which is transmitted using backward-communication time slots in a 5 ms frame assigned to the terminal (200), through a wireless communication channel (300) (S101). The encoded voice frame data received by the lower layer processing unit (101) is transmitted to an error detection unit (102).

The error detection unit 102 determines whether or not the relevant encoded voice frame data contains a transmission line error by performing a cyclic redundancy check (CRC) or the like on the encoded voice frame data (S102). If the encoded voice frame data contains a transmission line error, the error detection unit (102) sends notification thereof to a retransmission request discrimination unit (105) and transmits the encoded voice frame data to a voiced-or-unvoiced discrimination unit (104) through a voice encoding parameter storage register (103).

A voiced-or-unvoiced discrimination unit (104) determines whether or not the received encoded voice frame data corresponds to the voiced section (S103, S104). Specifically, the voiced-or-unvoiced discrimination unit (104) reads the voice encoding parameter storage register (103) so as to find a volume parameter corresponding to the latest encoded voice frame data without transmission line errors among the encoded voice frame data that has been received before the input encoded voice frame data. If the thus found volume parameter exceeds a predetermined threshold value, the voiced-or-unvoiced discrimination unit (104) regards the input encoded voice frame data as corresponding to the voiced section. As used herein, the volume parameter is a parameter related to the total energy of a volume frame or a pitch gain parameter. If the encoded voice frame data corresponds to the voiced section, the voiced-or-unvoiced discrimination unit (104) transmits the notification thereof with the encoded voice frame data to the retransmission request discrimination unit (105). Alternatively, instead of the voiced-or-unvoiced discrimination unit (104), a voiced-or-unvoiced estimation unit may be provided for estimating whether or not the input encoded voice frame data is corresponding to the voiced section based on some information.

Upon receiving the notification that the encoded voice frame data from the voiced-or-unvoiced discrimination unit (104) corresponds to the voiced section, the retransmission request discrimination unit (105) checks the wireless resource for retransmission and determines whether or not a wireless resource for retransmission is available (S105, S106). As shown in FIG. 2, the 5 ms frame reserved for retransmission (hereinafter referred to as retransmission 5-ms frame) is shared-use for retransmission of the encoded voice frame data from a plurality of terminals (200). Thus, when the retransmission 5-ms frame has been assigned to another terminal (200) for retransmission, the retransmission 5-ms frame is unavailable.

If the wireless resource for retransmission, i.e., the retransmission 5-ms frame, is available, the retransmission request discrimination unit (105) uses the forward-communication time slots in the 5 ms frame assigned to the terminal (200) from which the encoded voice frame data is transmitted and returns NAK as a retransmission request to the relevant terminal (200) through the lower layer processing unit (101) and the wireless communication channel (300) (S107).

Then, the lower layer processing unit (101) receives from the terminal (200) the encoded voice frame data, which is retransmitted using the backward-communication time slots in the retransmission 5-ms frame, through the wireless communication channel (300) (S108) The encoded voice frame data received by the lower layer processing unit (101) is transmitted to the error detection unit (102).

The error detection unit (102) determines whether or not the retransmitted encoded voice frame data contains a transmission line error (S109). If the encoded voice frame data contains a transmission line error, the error detection unit (102) sends notification thereof to the retransmission request discrimination unit (105) and transmits the encoded voice frame data to an error frame processing unit (106).

Upon receiving from the error detection unit (102) the notification that a transmission line error is detected in the encoded voice frame data, the retransmission request discrimination unit (105) uses the forward-communication time slots in the retransmission 5-ms frame and returns NAK as a notification that the receipt has completed unsuccessfully to the terminal (200) from which the encoded voice frame data is transmitted (S110).

The error frame processing unit (106) performs error frame processing, which is defined by the sound code system, on the encoded voice frame data from the error detection unit (102) (S111). For example, the error frame processing unit (106) may reuse the encoded voice frame data which has been received before the input encoded voice frame data. The encoded voice frame data subjected to error frame processing is transmitted to the voice decoding unit (107).

After completion of error processing by the error frame processing unit (106), the retransmission request discrimination unit (105) uses the forward-communication time slots in the retransmission 5-ms frame and returns ACK as a notification of successful receipt to the terminal (200) from which the encoded voice frame data is transmitted (S112). After that, the voice decoding unit (107) decodes the input encoded voice frame data (S113).

Further, if it is determined, in S109, that the encoded voice frame data does not contain a transmission line error, the error detection unit (102) sends notification thereof to the retransmission request discrimination unit (105) and transmits the encoded voice frame data to the voice decoding unit (107) through the error frame processing unit (106). Upon receiving the notification that a transmission line error is not contained in the encoded voice frame data, the retransmission request discrimination unit (105) uses the forward-communication time slots in the retransmission 5-ms frame and returns ACK as a notification that the receipt has completed successfully to the terminal (200) from which the encoded voice frame data is transmitted (S112). After that, the voice decoding unit (107) decodes the input encoded voice frame data (S113).

Further, if it is determined, in S106, that a wireless resource for retransmission is unavailable, the retransmission request discrimination unit (105) transmits the encoded voice frame data from the voiced-or-unvoiced discrimination unit (104) to the error frame processing unit (106). The error frame processing unit (106) performs error frame processing on the encoded voice frame data from the error detection unit (105) (S311). After completion of the error processing by the error frame processing unit (106), the retransmission request discrimination unit (105) uses the forward-communication time slots in the retransmission 5-ms frame assigned to the terminal (200) from which the encoded voice frame data is transmitted and returns ACK as a notification that the receipt has completed successfully to the relevant terminal (200) (S112). After that, the voice decoding unit (107) decodes the encoded voice frame data from the error frame processing unit (106) (S113).

In addition, if it is determined, in S104, that the encoded voice frame data does not correspond to a voiced section, the voiced-or-unvoiced discrimination unit (104) transmits notification thereof and the encoded voice frame data to the retransmission request discrimination unit (105). Upon receiving this notification, the retransmission request discrimination unit (105) transmits the encoded voice frame data to the error frame processing unit (106). Then, the error frame processing unit (106) performs error frame processing on the encoded voice frame data (S111) After completion of the error processing by the error frame processing unit (106), the retransmission request discrimination unit (105) uses the forward-communication time slots in the retransmission 5-ms frame assigned to the terminal (200) from which the encoded voice frame data is transmitted and returns ACK as a notification that the receipt has completed successfully to the relevant terminal (200) (S112) After that, the voice decoding unit (107) decodes the encoded voice frame data from the error frame processing unit (106) (S113).

Furthermore, if it is determined, in S102, that the encoded voice frame data does not contain a transmission line error, the error detection unit (102) sends notification thereof to the retransmission request discrimination unit (105) and transmits the encoded voice frame data to the voice decoding unit (107) through the error frame processing unit (106). Upon receiving notification that a transmission line error is not contained in the encoded voice frame data, the retransmission request discrimination unit (105) uses the forward-communication time slots in the retransmission 5-ms frame and returns ACK as a notification that receipt has completed successfully to the terminal (200) from which the encoded voice frame data is transmitted (S112). After that, the voice decoding unit (107) decodes the input encoded voice frame data (S113).

FIG. 3 is a flow chart showing operations of the terminal (200). A voice encoding unit (201) in the terminal (200) encodes voice in a frame time of 20 ms and generates encoded voice data (S201). The encoded voice data is transmitted to a header adding unit (202).

The header adding unit (202) adds a header to this encoded voice data and generates encoded voice frame data (S202). The encoded data so generated is transmitted to the lower layer processing unit (203).

The lower layer processing unit (203) uses the forward-communication time slots in the 5 ms frame assigned to the terminal (200) and transmits the encoded voice frame data to the base station device (100) through the wireless communication channel (300) (S203). The base station device (100) that receives the encoded voice frame data carries out the procedures of S101 to S113 in FIG. 3.

Then, the lower layer processing unit (203) receives data, which is transmitted using the forward-communication time slots in the 5 ms frame assigned to the terminal (200), from the base station device (100) (S204). The data received here contains NAK that is returned from the base station device (100) to the terminal (200) in S107 or ACK that is returned from the base station device (100) to the terminal (200) in step S112 as shown in FIG. 3. The data thus received is transmitted to the retransmission control unit (204).

The retransmission control unit (204) distinguishes ACK and NAK contained in the data transmitted through the forward-communication time slots and determines whether or not NAK is contained (S205, S206). If ACK is contained in the data, the sequence of operations terminates.

On the other hand, if NAK is contained in the data, the retransmission control unit (204) instructs the lower layer processing unit (203) to perform retransmission. Based on this instruction, the lower layer processing unit (203) uses the backward-communication time slots in the retransmission 5-ms frame and retransmits the encoded voice frame data, which was transmitted in S203, to the base station device (100) (S207).

Then, the lower layer processing unit (203) receives data, which is transmitted using the forward-communication time slots in the retransmission 5-ms frame, from the base station device (100) (5208). The data received here contains NAK that is returned from the base station device (100) to the terminal (200) in S110 or (ACK) that is returned from the base station device (100) to the terminal (200) in step S112 as shown in FIG. 3. The data thus received is transmitted to the retransmission control unit (204).

The retransmission control unit (204) distinguishes ACK and NAK contained in the data transmitted through the forward-communication time slots (S209) and determines whether or not NAK is contained (S210). If ACK is contained in the data, the sequence of operations terminates. On the other hand, if NAK is contained in the data, the retransmission control unit (204) adds 1 to a backward communication error number count rate that the retransmission control unit (204) holds. After that, if the count rate per unit time exceeds a predetermined threshold value, the retransmission control unit (204) can execute control as required, for example, by interrupting retransmission or performing retransmission while lowering the bit rate.

As described above, with the base station device (100) acting as a communication device for the invention, if a transmission error is contained in the encoded voice frame data from the terminal (200) and the encoded voice frame data corresponds to the voiced section, within the 20 ms frame time corresponding to the encoded voice frame data the base station device (100) returns NAK as a retransmission request to the terminal (200) using the forward communication time slots in a retransmission 5-ms frame and causes the terminal (200) to retransmit the encoded voice frame data.

Therefore, even when a transmission line error is detected in encoded voice information, if the encoded voice frame data corresponds to the unvoiced section, no retransmission request is conducted since such information is not necessary for voice decompression. Accordingly, it becomes possible to provide voice communication with reduced processing load and making effective use of radio resources while minimizing the necessity for retransmission.

In the aforementioned embodiment, the retransmission 5-ms frame is reserved beforehand. However, when the traffic amount of the overall communication system increases and exceeds a predetermined threshold value, the base station device (100) may assign the retransmission 5-ms frame to the terminal (200) and suspend the control of retransmission.

Furthermore, in this embodiment, while the foregoing description is given for the transmission of the encoded voice frame data to be transmitted from the terminal (200) to the base station device (100), the invention may also be applicable to transmission from the base station device (100) to the terminal (200) and also applicable to transmission between any two specific communication devices.

1. A communication device for decoding received encoded voice information on a frame-by-frame basis, comprising a detection section for detecting transmission line errors of encoded voice information on the frame-by-frame, a discrimination/estimation section for discriminating and/or estimating whether or not encoded voice information corresponds to the voiced section on the frame-by-frame, and a retransmission request section for requesting retransmission of the voice encoded voice information, from which the detection section detects transmission line errors and which the discrimination/estimation section discriminates and/or estimates as belonging to the voiced section, within the time corresponding to the frame.

2. The communication device according to claim 1, wherein if the volume level corresponding to the encoded voice information exceeds a predetermined threshold level, the discrimination/estimation section discriminates and/or estimates that the encoded voice information corresponds to the voiced section.

3. The communication device according to claim 1 or 2, wherein the discrimination/estimation section discriminates and/or estimates whether or not newly-received encoded voice information corresponds to the voiced section based on a volume level corresponding to the already-received encoded voice information with no transmission line errors.

4. The communication device according to claim 3, wherein the retransmission request section requests retransmission when an unassigned radio resource is present within the time corresponding to the frame.

5. A communication method for decoding received encoded voice information on a frame-by-frame basis, comprising a detection step of detecting the transmission line errors of encoded voice information on the frame-by-frame, a discrimination/estimation step of discriminating and/or estimating whether or not encoded voice information corresponds to the voiced section on the frame-by-frame, and a retransmission request step for requesting retransmission of the voice encoded voice information, from which the detection step detects transmission line errors and which the discrimination/estimation step discriminates and/or estimates as belonging to the voiced section, within the time corresponding to the frame.

6. The communication method according to claim 5, wherein if the volume level corresponding to the encoded voice information exceeds a predetermined threshold level, the discrimination/estimation step discriminates and/or estimates that the encoded voice information corresponds to the voiced section.

7. The communication method according to claim 5 or 6, wherein the discrimination/estimation step discriminates and/or estimates whether or not newly-received encoded voice information corresponds to the voiced section based on a volume level corresponding to the already-received encoded voice information with no transmission line errors.

8. The communication method according to claim 7, wherein the retransmission request step requests retransmission when an unassigned radio resource is present within the time corresponding to the frame.
